(19) United States
(12) Patent Application Publication
(10) Pub. No.: US 2023/0321866 A1
(43) Pub. Date: Oct. 12, 2023

(54) Multi-Cavity Forming Mould System and a Method for Forming Cellulose Products in a Multi-Cavity Forming Mould System

(71) Applicant: PulPac AB, Västra Frölunda (SE)

(72) Inventors: Ove Larsson, Västra Frölunda (SE); Olle Högblom, Göteborg (SE)

(21) Appl. No.: 18/041,940

(22) PCT Filed: Aug. 20, 2021
(86) PCT No.: PCT/EP2021/073177

§ 371 Date: Feb. 16, 2023

(30) Foreign Application Priority Data
Aug. 26, 2020 (SE) 2050980-8

(51) Int. Cl. B27N 5/02; B27N 3/20; B27N 1/00; B27N 3/04

(52) U.S. Cl. CPC B27N 5/02; B27N 3/203; B27N 1/00; B27N 3/04

(57) ABSTRACT

A multi-cavity forming mould system for forming a plurality of discrete three-dimensional cellulose products from an air-formed cellulose blank structure. The forming mould system includes a first mould part and a second mould part arranged for cooperating with each other during forming of the cellulose products. The first mould part includes a plurality of first forming elements and the second mould part comprises a plurality of corresponding second forming elements movably arranged in relation to a base structure of the second mould part. The forming mould system is configured for establishing a plurality of forming cavities for the cellulose blank structure between each first forming element and corresponding second forming element during formation of the cellulose products. Each second forming element is arranged for interacting with a pressure member arranged in the base structure, where the pressure member is configured for establishing a forming pressure in each forming cavity onto the cellulose blank structure during formation of the cellulose products.

### TECHNICAL FIELD

The present disclosure relates to a forming mould system for forming a plurality of discrete three-dimensional cellulose products from an air-formed cellulose blank structure. The forming mould system comprises a first mould part and a second mould part arranged for cooperating with each other during forming of the cellulose products. The first mould part comprises first forming elements and the second mould part comprises corresponding second forming elements. The disclosure further relates to a method for forming a plurality of three-dimensional cellulose products in a forming mould system.

### BACKGROUND

Cellulose fibers are often used as raw material for producing or manufacturing products. Products formed of cellulose fibers can be used in many different situations where there is a need for having sustainable products. A wide range of products can be produced from cellulose fibers and a few examples are disposable plates and cups, cutlery, lids, bottle caps, coffee pods, and packaging materials.

Forming moulds are commonly used when manufacturing cellulose products from raw materials including cellulose fibers, and traditionally the cellulose products have been produced with wet-forming techniques. A material commonly used for wet-forming cellulose fiber products is wet moulded pulp. Wet moulded pulp has the advantage of being considered as a sustainable packaging material, since it is produced from biomaterials and can be recycled after use. Consequently, wet moulded pulp has been quickly increasing in popularity for different applications. Wet moulded pulp articles are generally formed by immersing a suction forming mould into a liquid or semi liquid pulp suspension or slurry comprising cellulose fibers, and when suction is applied, a body of pulp is formed with the shape of the desired product by fiber deposition onto the forming mould. With all wet-forming techniques, there is a need for drying of the wet moulded product, where the drying is a very time and energy consuming part of the production. The demands on aesthetical, chemical and mechanical properties of cellulose products are increasing, and due to the properties of wet-formed cellulose products, the mechanical strength, flexibility, freedom in material thickness, and chemical properties are limited. It is also difficult in wet-forming processes to control the mechanical properties of the products with high precision.

One development in the field of producing cellulose products is the forming of cellulose fibers without using wet-forming techniques. Instead of forming the cellulose products from a liquid or semi liquid pulp suspension or slurry, an air-formed cellulose blank structure is used. The air-formed cellulose blank structure is inserted into a forming mould and during the forming of the cellulose products the cellulose blank structure is subjected to a high forming pressure and a high forming temperature, for example by using standard pressing equipment. The forming systems used for forming cellulose products from air-formed cellulose blank structures are limited in production capacity, since the forming of the cellulose products take place in forming systems with relatively long cycle times. The high pressure needed when forming the cellulose products is limiting the number of products that can be formed in a single pressure-forming step, and requires expensive high precision pressing equipment. One common issue with forming more than one product in a single pressure-forming step is to establish an even forming pressure on the air-formed cellulose blank structure. An even forming pressure is desired for achieving cellulose products with high quality.

There is thus a need for an improved method and system for forming cellulose products from an air-formed cellulose blank structure.

### SUMMARY

An object of the present disclosure is to provide a multi-cavity forming mould system, and a method for forming a plurality of discrete three-dimensional cellulose products in a multi-cavity forming mould system, where the previously mentioned problems are avoided. This object is at least partly achieved by the features of the independent claims. The dependent claims contain further developments of the system and the method.

The disclosure concerns a multi-cavity forming mould system for forming a plurality of discrete three-dimensional cellulose products from an air-formed cellulose blank structure. The forming mould system comprises a first mould part and a second mould part arranged for cooperating with each other during forming of the cellulose products. The first mould part comprises a plurality of first forming elements and the second mould part comprises a plurality of corresponding second forming elements. The second forming elements are movably arranged in relation to a base structure of the second mould part. The forming mould system is configured for establishing a plurality of forming cavities for the cellulose blank structure between each first forming element and corresponding second forming element during forming of the cellulose products. Each second forming element is arranged for interacting with a pressure member arranged in the base structure, and the pressure member is configured for establishing a forming pressure in each forming cavity onto the cellulose blank structure during forming of the cellulose products.

Advantages with these features are that the pressure member arranged in the base structure is establishing a forming pressure in all forming cavities onto the cellulose blank structure during forming of the plurality of discrete three-dimensional cellulose products in one common forming step. With the forming pressure in all forming cavities, the cellulose products can be formed with high quality without the limited production capacity when forming only one product at a time in one common forming step. The plurality of forming elements are increasing the production capacity, even if the forming mould system used is having a relatively long cycle time. The cycle time may vary depending on the type of cellulose products produced in the forming mould system. The forming pressure is suitably equal or essentially equal in all forming cavities for an even pressure distribution when forming the cellulose products. With the mould system comprising the pressure member, the even forming pressure established during the forming process is resulting in cellulose products having high quality without quality variations between the cellulose products formed. Alternatively, the forming pressure may differ between forming cavities, and the pressure member may be configured for distributing two or more differing pressure levels to the forming cavities, which may be useful if different types of cellulose products are simultaneously produced in the multi-cavity forming mould system.

According to an aspect of the disclosure, the first mould part and the second mould part are movably arranged in relation to each other. The movable arrangement of the mould parts is providing an efficient way for establishing the plurality of forming cavities for the cellulose blank structure between each first forming element and corresponding second forming element. The movement of the mould parts could also be used for positioning the cellulose blank structure into the forming cavities between the first and second forming elements.

According to another aspect of the disclosure, the forming mould system is configured for establishing the forming pressure upon movement of each second forming element in relation to the base structure through interaction from the pressure member. The movable arrangement of each second forming element is efficiently establishing the forming pressure in the forming mould system together with the interaction from the pressure member, where the pressure member is establishing a suitable pressure level together with the movement of each second forming element.

According to an aspect of the disclosure, the forming mould system is through interaction from the pressure member configured for establishing a forming pressure level of at least 1 MPa, preferably in the range 4-20 MPa, in each forming cavity during forming of the cellulose products. These pressure levels are used for establishing an efficient forming of the plurality of cellulose products in each forming step, where the cellulose products could be produced with high quality through the interaction between the pressure member and each second forming element.

According to another aspect of the disclosure, the pressure member comprises a plurality of spring units arranged between the base structure and each of the plurality of second forming elements. The plurality of spring units are suitable to use as pressure member through the interaction with each movably arranged second forming element. When the first mould part and second mould part are cooperating with each other during forming of the cellulose products and when the plurality of forming cavities for the cellulose blank structure are established between each first forming element and corresponding second forming element, the pressure member could be used for establishing a determined forming pressure exerted on the cellulose blank structure. The movable arrangement of each second mould part in relation to the base structure is controlling the forming pressure together with the corresponding interacting spring.

According to a further aspect of the disclosure, the pressure member comprises a hydraulic pressure unit. The hydraulic pressure unit comprises a plurality of pressure chambers arranged between the base structure and each of the plurality of second forming elements. The hydraulic pressure unit is suitable to use as pressure member through the interaction with each movably arranged second forming element. When the first mould part and second mould part are cooperating with each other during forming of the cellulose products and when the plurality of forming cavities for the cellulose blank structure are established between each first forming element and corresponding second forming element, the hydraulic pressure unit could be used for establishing the forming pressure exerted on the cellulose blank structure. The hydraulic pressure unit is used for exerting a hydraulic pressure onto each second mould part for establishing the forming pressure in each forming cavity. When the second forming elements through the hydraulic pressure are moved in a direction towards the first forming elements, the forming pressure is established in a precise and efficient way.

According to an aspect of the disclosure, the forming mould system comprises a heating unit configured for heating the cellulose blank structure to a forming temperature in the range of 100° C. to 300° C. during forming of the cellulose products. The heating unit is heating the cellulose blank structure to a desired forming temperature, and the heating unit may for example be arranged in the mould parts for heating the cellulose blank structure during the forming process.

The disclosure further concerns a method for forming a plurality of discrete three-dimensional cellulose products from an air-formed cellulose blank structure in a multi-cavity forming mould system. The forming mould system comprises a first mould part and a second mould part arranged for cooperating with each other during forming of the cellulose products. The first mould part comprises a plurality of first forming elements and the second mould part comprises a plurality of corresponding second forming elements. The second forming elements are movably arranged in relation to a base structure of the second mould part. Each second forming element is arranged for interacting with a pressure member arranged in the base structure. The method comprises the steps: providing the air-formed cellulose blank structure, where the cellulose blank structure is air-formed from cellulose fibers, and arranging the cellulose blank structure between the first mould part and the second mould part; establishing a plurality of forming cavities for the cellulose blank structure between each first forming element and corresponding second forming element; establishing a forming pressure in each forming cavity onto the cellulose blank structure with the pressure member during forming of the cellulose products.

Advantages with this method are that the pressure member is establishing a forming pressure in all forming cavities onto the cellulose blank structure during forming of the plurality of discrete three-dimensional cellulose products. With the forming pressure in all forming cavities, the cellulose products can be formed with high quality and production capacity in one common forming step in less expensive and precise pressing equipment. The forming pressure is suitably equal or essentially equal in all forming cavities for an even pressure distribution when forming the cellulose products. With the mould system comprising the pressure member, the even forming pressure established during the forming process is resulting in cellulose products having high quality without quality variations between the cellulose products formed. Alternatively, the forming pressure may differ between forming cavities, and the pressure member may be configured for distributing two or more differing pressure levels to the forming cavities, which may be useful if different types of cellulose products are simultaneously produced in the multi-cavity forming mould system.

According to an aspect of the disclosure, the method further comprises the steps: moving the first mould part and the second mould part in a direction towards each other after arranging the cellulose blank structure between the first mould part and the second mould part for establishing the plurality of forming cavities for the cellulose blank structure. The movement of the mould parts is providing an efficient way for establishing the plurality of forming cavities for the cellulose blank structure between each first forming element and corresponding second forming element. The movement of the mould parts is positioning the cellulose blank structure into the forming cavities between the first and second forming elements.

According to another aspect of the disclosure, the method further comprises the steps: establishing the forming pressure upon movement of each second forming element in relation to the base structure through interaction from the pressure member. The movement of each second forming element is efficiently establishing the forming pressure in the forming mould system together with the interaction from the pressure member. The pressure member is establishing a suitable pressure level together with the movement of each second forming element.

According to an aspect of the disclosure, the method further comprises the steps: establishing a forming pressure level of at least 1 MPa, preferably in the range 4-20 MPa, in each forming cavity through interaction from the pressure member. These pressure levels are used for establishing an efficient forming of the plurality of cellulose products in each forming step, where the cellulose products could be produced with high quality through the interaction between the pressure member and each second forming element.

According to another aspect of the disclosure, the pressure member comprises a plurality of spring units arranged between the base structure and each of the plurality of second forming elements. The spring units are establishing the forming pressure in each forming cavity onto the cellulose blank structure. The plurality of spring units are suitable for establishing the forming pressure in each forming cavity through the interaction with each movably arranged second forming element. When the first mould part and second mould part are cooperating with each other during forming of the cellulose products and when the plurality of forming cavities for the cellulose blank structure are established between each first forming element and corresponding second forming element, the pressure member could be used for establishing the forming pressure exerted on the cellulose blank structure. The movable arrangement of each second mould part in relation to the base structure is controlling the forming pressure together with the corresponding interacting spring unit. Each spring unit is lowering the stiffness of the forming mould system for enabling the movable arrangement of each second forming element. A mechanical or hydraulic press could then be used for moving the first mould part with less geometrical precision in a pressing direction of the mould parts. The pressure members are making the forming process more robust even when using several cavities and less expensive pressing equipment with lower tolerances.

According to a further aspect of the disclosure, the pressure member comprises a hydraulic pressure unit. The hydraulic pressure unit comprises a plurality of pressure chambers arranged between the base structure and each of the plurality of second forming elements. The hydraulic pressure unit is establishing the forming pressure in each forming cavity onto the cellulose blank structure. The hydraulic pressure unit is suitable for establishing the forming pressure in each forming cavity through the interaction with each movably arranged second forming element. When the first mould part and second mould part are cooperating with each other during forming of the cellulose products and when the plurality of forming cavities for the cellulose blank structure are established between each first forming element and corresponding second forming element, the hydraulic pressure unit is establishing the forming pressure exerted on the cellulose blank structure. The hydraulic pressure unit is used for exerting a hydraulic pressure onto each second mould part for establishing the forming pressure in each forming cavity. The forming pressure is established in a precise and efficient way when the second forming elements through the hydraulic pressure are moved in a direction towards the first forming elements. When using a hydraulic pressure unit, the tolerance requirements of a moving arrangement of the first mould part is even lower compared to when using springs. The motion of the first mould part could for example be generated by a mechanical or hydraulic press, which is used only for establishing the forming cavities. The hydraulic pressure unit is enabling the use of very simple devices for moving the first mould part, like mechanical clamping units of toggle type, traditionally used in injection moulding of thermoplastics. The difference in cost between standard pressing equipment and a clamping unit for injection moulding could be as high as ten times higher, in favor of the clamping unit for establishing an equal force. Moreover, the cycle time of a forming mould system using clamping unit and hydraulic pressure members can be halved or even shorter compared to when using standard pressing equipment.

According to an aspect of the disclosure, the forming mould system comprises a heating unit. The method further comprises the step: heating the cellulose blank structure to a forming temperature in the range of 100° C. to 300° C. during forming of the cellulose products. The heating unit is heating the cellulose blank structure to a desired forming temperature, and the heating unit may for example be arranged in the mould parts for heating the cellulose blank structure during the forming process.

### BRIEF DESCRIPTION OF THE DRAWINGS

The disclosure will be described in detail in the following, with reference to the attached drawings, in which:

FIGS. 1a-f show schematically, in cross-sectional side views, a multi-cavity forming mould system according to the disclosure,

FIGS. 2a-c show schematically, in cross-sectional side views, an alternative embodiment of the multi-cavity forming mould system according to the disclosure,

FIG. 3 shows schematically, in a side view, a production unit layout of the multi-cavity forming mould system according to the disclosure,

FIG. 4 shows schematically, in a perspective view, an alternative embodiment of a production unit layout of the multi-cavity forming mould system according to the disclosure, and

FIG. 5 shows schematically, in a perspective view, a first mould part and a second mould part of the multi-cavity forming mould system according to the disclosure.

### DETAILED DESCRIPTION OF THE DRAWINGS

Various aspects of the disclosure will hereinafter be described in conjunction with the appended drawings to illustrate and not to limit the disclosure, wherein like designations denote like elements, and variations of the described aspects are not restricted to the specifically shown embodiments, but are applicable on other variations of the disclosure.

Those skilled in the art will appreciate that the steps, services and functions explained herein, or parts of steps, services and functions explained herein, may be implemented by using individual hardware circuitry, using software functioning in conjunction with a programmed microprocessor or general purpose computer, using one or more Application Specific Integrated Circuits (ASICs) and/or using one or more Digital Signal Processors (DSPs). It will also be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

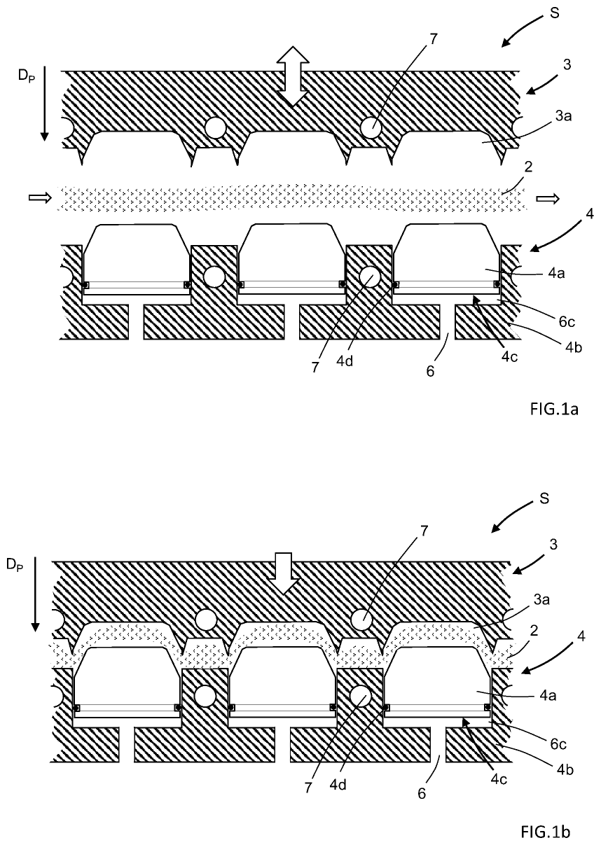

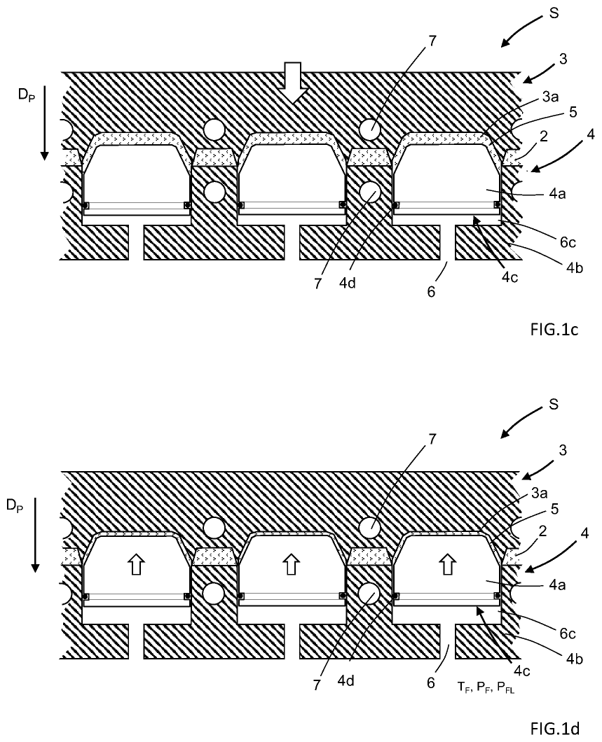

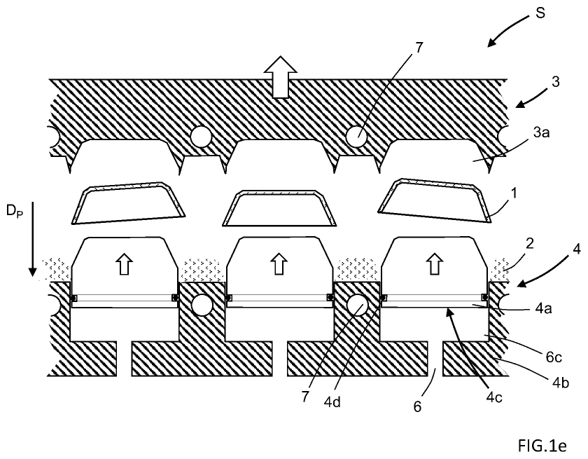

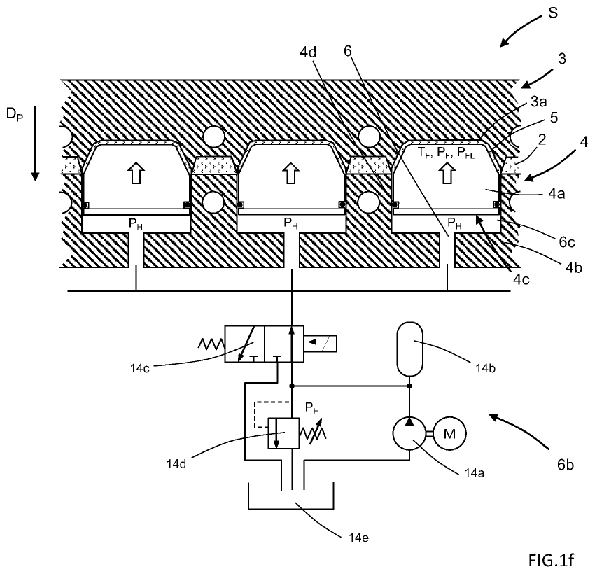

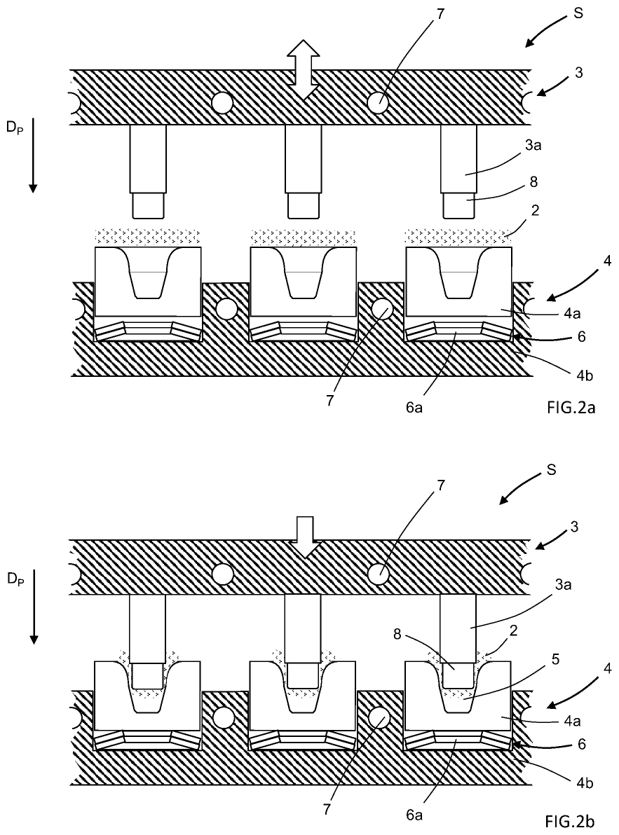

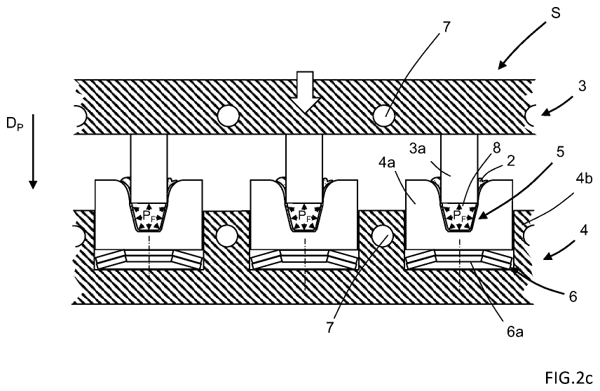

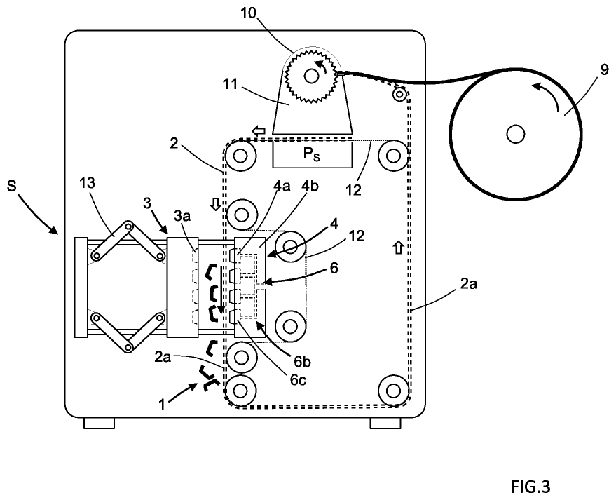

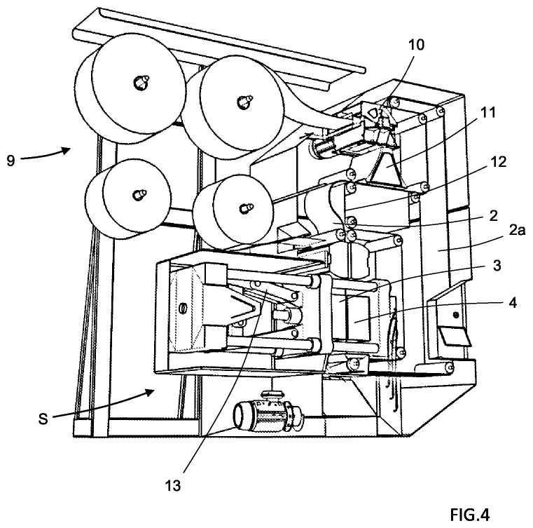

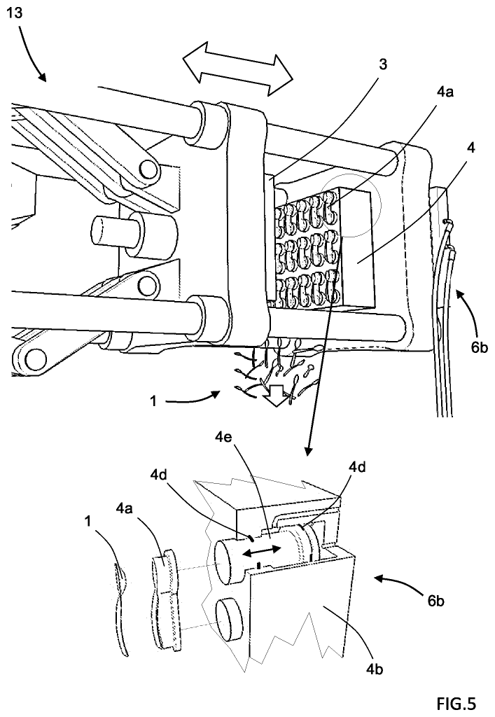

The disclosure concerns a multi-cavity forming mould system S for forming a plurality of discrete three-dimensional cellulose products 1 from an air-formed cellulose blank structure 2. FIGS. 1a-f schematically show a first exemplary embodiment of the multi-cavity forming mould system S. An alternative exemplary embodiment of the multi-cavity forming mould system S is illustrated in FIGS. 2a-c. Schematic production unit layouts of the multi-cavity forming mould system S is illustrated in FIGS. 3 and 4, and a first mould part 3 and a second mould part 4 of the multi-cavity forming system S are shown in a perspective view in FIG. 5.

With a cellulose blank structure 2 is according to the disclosure meant a fiber web structure produced from cellulose fibers. With air-forming of the cellulose blank structure 2 is meant the formation of a cellulose blank structure in a dry-forming process in which cellulose fibers are air-formed to produce the cellulose blank structure. When forming the cellulose blank structure 2 in the air-forming process, the cellulose fibers are carried and formed to the fiber blank structure 2 by air as carrying medium. This is different from a normal papermaking process or a traditional wet-forming process, where water is used as carrying medium for the cellulose fibers when forming the paper or fiber structure. In the air-forming process, small amounts of water or other substances may if desired be added to the cellulose fibers in order to change the properties of the cellulose product, but air is still used as carrying medium in the forming process. The cellulose blank structure 2 may, if suitable have a dryness that is mainly corresponding to the ambient humidity in the atmosphere surrounding the air-formed cellulose blank structure 2. As an alternative, the dryness of the cellulose blank structure 2 can be controlled in order to have a suitable dryness level when forming the cellulose products 1.

The cellulose blank structure 2 may be formed of cellulose fibers in a conventional air-forming process and be configured in different ways. For example, the cellulose blank structure 2 may have a composition where the fibers are of the same origin or alternatively contain a mix of two or more types of cellulose fibers, depending on the desired properties of the cellulose products 1. The cellulose fibers used in the cellulose blank structure 2 are during the forming process of the cellulose products 1 strongly bonded to each other with hydrogen bonds. The cellulose fibers may be mixed with other substances or compounds to a certain amount. With cellulose fibers is meant any type of cellulose fibers, such as natural cellulose fibers or manufactured cellulose fibers.

The cellulose blank structure 2 may have a single-layer or a multi-layer configuration. A cellulose blank structure 2 having a single-layer configuration is referring to a cellulose blank structure that is formed of one layer containing cellulose fibers. A cellulose blank structure 2 having a multi-layer configuration is referring to a cellulose blank structure that is formed of two or more layers comprising cellulose fibers, where the layers may have the same or different compositions or configurations. The cellulose blank structure 2 may comprise a reinforcement layer comprising cellulose fibers, where the reinforcement layer is arranged as a carrying layer for other layers of the cellulose blank structure 2. The reinforcement layer may have a higher tensile strength than other layers of the cellulose blank structure 2. This is useful when one or more layers of the cellulose blank structure 2 have compositions with low tensile strength in order to avoid that the cellulose blank structure 2 will break during the forming of the cellulose products 1. The reinforcement layer with a higher tensile strength acts in this way as a supporting structure for other layers of the cellulose blank structure 2. The reinforcement layer may for example be a tissue layer containing cellulose fibers, an airlaid structure comprising cellulose fibers, or other suitable layer structures.

The cellulose blank structure 2 is a fluffy and airy structure, where the cellulose fibers forming the structure is arranged relatively loosely in relation to each other. The fluffy cellulose blank structure 2 is used for an efficient forming of the cellulose products 1, allowing the cellulose fibers to form the cellulose products 1 in an efficient way during the forming process.

As illustrated in FIGS. 1a-f, 2a-c, and 3-5, the multi-cavity forming mould system S comprises the first mould part 3 and the second mould part 4 arranged for cooperating with each other during forming of the cellulose products 1.

The first mould part 3 and the second mould part 4 are movably arranged in relation to each other, and the first mould part 3 and the second mould part 4 are configured for moving in relation to each other in a pressing direction D_{P}. In the embodiments illustrated in FIGS. 1a-f, and 2a-c, the second mould part 4 is stationary and the first mould part 3 is movably arranged in relation to the second mould part 4 in the pressing direction D_{P}. As indicated with the double arrow in FIGS. 1a and 2a, the first mould part 3 is configured to move both towards the second mould part 4 and away from the second mould part 4 in linear movements along an axis extending in the pressing direction D_{P}. In alternative embodiments, the first mould part 3 may be stationary with the second mould part 4 movably arranged in relation to the first mould part 3, or both mould parts may be movably arranged in relation to each other.

It should be understood that for all embodiments according to the disclosure, the expression moving in the pressing direction D_{P} includes a movement along an axis extending in the pressing direction D_{P}, and the movement may take place along the axis in opposite directions. The expression further includes both linear and non-linear movements of a mould part for all embodiments, where the result of the movement during forming is a repositioning of the mould part between two positions on the axis, where the axis is extending in the pressing direction D_{P}.

As further illustrated in FIGS. 1a-f, 2a-c, and 3-5, the first mould part 3 comprises a plurality of first forming elements 3a and the second mould part 4 comprises a plurality of corresponding second forming elements 4a. The second forming elements 4a are movably arranged in relation to a base structure 4b of the second mould part 4. The first forming elements 3a may for example be arranged as recesses or indentations arranged in the first mould part 3 as illustrated in the embodiment shown in FIGS. 1a-f, or alternatively as protrusions or extending parts that are extending out from the first mould part 3 as illustrated in the alternative embodiment shown in FIGS. 2a-c. The recesses or indentations as shown in FIGS. 1a-f, or alternatively the protrusions or extending parts as shown in FIGS. 2a-c, are arranged to cooperate with the corresponding second forming elements 4a of the second mould part 4 during the forming of the cellulose products 1. The second forming elements 4a may for example extend out from the base structure 4b as illustrated in the embodiments shown in FIGS. 1a-f and 2a-c, with shapes and configurations suitable for cooperating with the first forming elements 3a. The second forming elements 4a may for example be slidingly arranged in relation to the base structure 4b in the pressing direction D_{P}, and the base structure 4b may be provided with suitable openings or similar structures for housing the second forming elements 4a. The first forming elements 3a and the second forming elements 4a may have corresponding sizes and shapes, which could vary depending on the size and shape of the cellulose products 1 that are formed in the multi-cavity forming mould system S. The first mould part 3 and the second mould part 4 may be made of any suitable material, such as for example steel, aluminum, other metals or metallic materials, or alternatively from composite materials or a combination of different materials. In the illustrated embodiments, the first mould part 3 comprises three first forming elements 3a, and the second mould part 4 comprises three corresponding second forming elements 4a. However, the first and second mould parts may comprise any suitable number of cooperating forming elements, depending on the design and construction of the multi-cavity forming mould system S. With a plurality of first forming elements 3a and corresponding second forming elements 4a, is meant two or more first forming elements 3a and two or more corresponding second forming elements 4a.

The multi-cavity forming mould system S is configured for establishing a plurality of forming cavities 5 for the cellulose blank structure 2 between each first forming element 3a and corresponding second forming element 4a during forming of the cellulose products 1. The forming cavities 5 are defined by the space or volume that is formed between the first forming elements 3a and the second forming elements 4a during the forming process when the cellulose blanks structure 2 is positioned between the first mould part 3 and the second mould part 4. The forming cavities 5 are configured for providing the shape of the cellulose products 1 during the forming process. The cellulose blank structure 2 is thus arranged within the forming cavities 5 when forming the cellulose products 1 and the forming cavities 5 may be arranged with suitable shapes and configurations for forming a desired shape and size, or shapes and sizes, of the cellulose products 1.

In the embodiment illustrated in FIGS. 1a-f, the first forming elements 3a are arranged as female mould units and the second forming elements 4a as male mould units that are interacting with each other during the forming process, and the forming cavities 5 are formed between the first forming elements 3a and the second forming elements 4a during the forming process as illustrated in FIG. 1d. In the embodiment illustrated in FIGS. 2a-c, the first forming elements 3a are arranged as male mould units and the second forming elements 4a as female mould units that are interacting with each other during the forming process, and the forming cavities 5 are formed between the first forming elements 3a and the second forming elements 4a during the forming process as illustrated in FIG. 2c.

Each second forming element 4a is arranged for interacting with a pressure member 6 arranged in the base structure 4b. The pressure member 6 is configured for establishing a forming pressure P_{F} in each forming cavity 5 onto the cellulose blank structure 2 during forming of the cellulose products 1, as will be further described below. The forming mould system S is configured for establishing the forming pressure P_{F} upon movement of each second forming element 4a in relation to the base structure 4b through interaction from the pressure member 6. The forming pressure P_{F} is suitably equal or essentially equal in all forming cavities 5 for an even pressure distribution when forming the cellulose products 1, where the forming pressure P_{F} in the forming cavities 5 is established by the pressure member 6. Alternatively, the forming pressure P_{F} may differ between forming cavities 5, and the pressure member 6 may be configured for distributing two or more differing pressure levels to the forming cavities, which may be useful if different types of cellulose products 1 are simultaneously produced in the multi-cavity forming mould system S.

The multi-cavity forming mould system S is through interaction from the pressure member 6 configured for establishing a forming pressure level P_{FL} of at least 1 MPa, preferably in the range 4-20 MPa, in each forming cavity 5 during forming of the cellulose products 1. These pressure ranges are suitable for forming the cellulose products 1 in the system S, where strong hydrogen bonds are formed between the cellulose fibers in the cellulose blank structure 2. Thus, during the forming of the cellulose products 1 in the multi-cavity forming mould system S, the forming pressure level P_{FL} is at least 1 MPa, preferably in the range 4-20 MPa, in each forming cavity 5. As described above, the pressure level P_{FL} may be the same or essentially the same in all forming cavities 5 during the forming of the cellulose products 1, or alternatively the forming pressure level P_{FL} may differ between forming cavities 5 during the forming of the cellulose products 1.

In the embodiment illustrated in FIGS. 1a-f and 5, the pressure member 6 comprises a hydraulic pressure unit 6b. The hydraulic pressure unit 6b comprises a plurality of pressure chambers 6c arranged between the base structure 4b and each of the plurality of second forming elements 4a. The second forming elements 4b may be arranged with a piston part 4e configured as a hydraulic piston within the corresponding pressure chamber, as schematically shown in FIG. 5. By filling the pressure chambers 6c with a suitable pressure medium, such as for example hydraulic oil, the forming pressure P_{F} can be exerted onto the second forming elements 4a by the pressure medium. The pressure chambers 6a and the second forming elements may have any suitable corresponding shapes, such as for example a generally cylindrical shape. The pressure chamber 6c is connected to a hydraulic pump system, a hydraulic cylinder, a spring loaded hydraulic cylinder, or other similar system or device, which via channels arranged in the base structure 4b are generating the pressure exerted onto the second forming elements 4a with the pressure medium. One common hydraulic pump 14a may be connected to all pressure chambers 6c, as shown in FIG. 1f, or alternatively two or more hydraulic pumps may be used, such as for example one hydraulic pump connected to each pressure chamber 6c. In the embodiment shown in FIGS. 1a-f and 5, the pressure medium is exerting the pressure onto lower surfaces 4c of the second forming elements 4a, and the lower surfaces 4c are arranged in connection to the pressure chambers 6c. The second forming elements 4a may each comprise a sealing element 4d, which is forming a tight seal between each pressure chamber 6c and second forming element 4a. The hydraulic pump system used may have a traditional layout as schematically illustrated in FIG. 1f. The hydraulic pump 14a is driven by for example an electric motor and connected to the pressure chambers 6c via a forming pressure valve 14c for turning the hydraulic pressure on and off. A pressure control valve 14d is used for regulating the pressure level. The pressure medium may be stored in a tank 14e and expanded into an accumulator tank 14b. Pressure medium flowing out from the pressure chambers 6c and from the pressure control valve 14d is returned to the tank 14e, as understood from FIG. 1f. The components of the hydraulic pump system are connected with suitable conduits.

To form the plurality of discrete three-dimensional cellulose products 1 from an air-formed cellulose blank structure 2 in a multi-cavity forming mould system S in accordance with the embodiment illustrated in FIGS. 1a-f, the air-formed cellulose blank structure 2 is first provided from a suitable source. The cellulose blank structure 2 may be air-formed from cellulose fibers and arranged on rolls or in stacks. The rolls or stacks may thereafter be arranged in connection to the multi-cavity forming mould system S. Alternatively, the cellulose blank structure may be air-formed from cellulose fibers in connection to the multi-cavity forming mould system S and directly fed to the mould parts, as shown in FIGS. 3 and 4. The cellulose blank structure 2 is arranged between the first mould part 3 and the second mould part 4, as shown in FIG. 1a.

Thereafter, as indicated in FIG. 1b, the first mould part 3 and the second mould part 4 are moved in a direction towards each other for establishing the plurality of forming cavities 5 for the cellulose blank structure 2. In FIG. 1b, the first mould part 3 is moved towards the second mould part 4, and the plurality of forming cavities 5 for the cellulose blank structure 2 are established between each first forming element 3a and corresponding second forming element 4a, as shown in FIG. 1c. In the position shown in FIG. 1c, the first mould part 3 and the second mould part 4 are arranged in connection to each other. The cellulose blank structure 2 may in the position shown in FIG. 1c be cut to separate the cellulose blank structure 2 arranged inside the forming cavities 5 from the cellulose blank structure 2 arranged outside the forming cavities 5. The mould parts may be arranged with suitable cutting devices for such a cutting operation.

When the first mould part 3 and the second mould part 4 are arranged in connection to each other, the forming pressure P_{F} is established in each forming cavity 5 onto the cellulose blank structure 2 with the pressure member 6 during forming of the cellulose products 1. In FIG. 1d, the second forming elements 4a are moved towards the first mould part 3 through the hydraulic pressure established by the pressure member 6 in the pressure chambers 6c by the pressure medium. As described above, a suitable forming pressure level P_{FL} is at least 1 MPa, preferably in the range 4-20 MPa, in each forming cavity 5 through interaction from the pressure member 6. When the pressure medium is flowing into the pressure chambers 6c, the second forming elements 4a are pushed in a direction towards the first forming elements 3a for exerting the forming pressure P_{L} onto the cellulose blank structure 2 arranged in the forming cavity 5. The forming pressure P_{F} is thus established through movement of each second forming element 4a in relation to the base structure 4b through interaction from the pressure member 6. A suitable control unit may be used for controlling the pressure levels exerted onto the second forming elements by the pressure medium. During the forming of the cellulose products 1, the cellulose blank structure 2 is heated to a forming temperature T_{F} in the range of 100° C. to 300° C. The forming pressure level P_{FL} is suitably equal or essentially equal in all forming cavities 5 for an even pressure distribution when forming the cellulose products 1. Alternatively, the forming pressure P_{F} may differ between forming cavities 5.

Once the cellulose products 1 have been formed in the multi-cavity forming mould system S the first mould part 3 is moved in a direction away from the second mould part 4, as schematically illustrated in FIG. 1e. The second forming elements 4a may be pushed in a direction away from the base structure 4b for easy removal of the cellulose products 1 after forming, as indicated with arrows in FIG. 1e. A spring, a cylinder, such as a double-acting cylinder, or similar device may be used in connection to each second forming element 4b for returning the forming elements 4b to the initial position shown in FIG. 1a after releasing the hydraulic pressure.

In the embodiment illustrated in FIGS. 2a-c, the pressure member 6 comprises a plurality of spring units 6a arranged between the base structure 4b and each of the plurality of second forming elements 4a. Each of the spring units 6a may be arranged as a single spring or as two or more cooperating springs, and the spring or springs are suitably compression springs. In the embodiment illustrated in FIGS. 2a-c, each of the spring units 6a is arranged as a stack of cooperating disc springs for establishing the forming pressure P_{F} in each forming cavity 5 onto the cellulose blank structure 2 during forming of the cellulose products 1. Other springs that may be used instead of the disc springs are for example helical springs or other types of washer springs.

To form the plurality of discrete three-dimensional cellulose products 1 from an air-formed cellulose blank structure 2 in the multi-cavity forming mould system S in accordance with the embodiment illustrated in FIGS. 2a-c, the air-formed cellulose blank structure 2 is first provided from a suitable source. The cellulose blank structure 2 may be air-formed from cellulose fibers and arranged on rolls or in stacks. The rolls or stacks may thereafter be arranged in connection to the multi-cavity forming mould system S. Alternatively, the cellulose blank structure may be air-formed from cellulose fibers in connection to the multi-cavity forming mould system S and directly fed to the mould parts. The cellulose blank structure 2 is in this embodiment arranged as pre-cut discrete pieces of material between the first mould part 3 and the second mould part 4, as shown in FIG. 2a.

Thereafter, as indicated in FIG. 2b, the first mould part 3 and the second mould part 4 are moved in a direction towards each other for establishing the plurality of forming cavities 5 for the cellulose blank structure 2. In FIG. 2b, the first mould part 3 is moved towards the second mould part 4, and the plurality of forming cavities 5 for the cellulose blank structure 2 are established between each first forming element 3a and corresponding second forming element 4a.

When the first mould part 3 and the second mould part 4 are arranged in connection to each other, the forming pressure P_{F} is established in each forming cavity 5 onto the cellulose blank structure 2 with the pressure member 6 during forming of the cellulose products 1. In FIG. 2c, the second forming elements 4a are moved in a direction away from the first mould part 3 through the interaction between the first forming elements 3a and the second forming elements 4a. When the second forming elements 4a are moved into the base structure 4b, the spring units 6a are compressed, and through the compression, the forming pressure level P_{FL} is exerted onto the cellulose blank structure 2 in the forming cavities 5. A suitable control unit may be used for determining the movement of the first mould part 3 in relation to the second mould part 4 for controlling the forming pressure. As described above, a suitable forming pressure level P_{FL} is at least 1 MPa, preferably in the range 4-20 MPa, in each forming cavity 5 through interaction from the pressure member 6. The forming pressure P_{F} is established through movement of each second forming element 4a in relation to the base structure 4b through interaction from the pressure member 6. During the forming of the cellulose products 1, the cellulose blank structure 2 is heated to a forming temperature T_{F} in the range of 100° C. to 300° C. The forming pressure level P_{FL} is suitably equal or essentially equal in all forming cavities 5 for an even pressure distribution when forming the cellulose products 1. Alternatively, the forming pressure P_{F} may differ between forming cavities 5.

Once the cellulose products have been formed in the multi-cavity forming mould system S, the first mould part 3 is moved in a direction away from the second mould part 4, and the cellulose products 1 can be removed, for example by using ejector rods or similar devices.

It should be understood that other pressure members 6 than the ones described may be used for establishing the forming pressure P_{F} in the forming cavities 5.

The multi-cavity forming mould system S further comprises a heating unit 7 configured for heating the cellulose blank structure 2 to the forming temperature T_{F} in the range of 100° C. to 300° C. during forming of the cellulose products 1. This temperature range is together with the pressure ranges described above suitable for forming the cellulose products 1 in the system S, where strong hydrogen bonds are formed between the cellulose fibers in the cellulose blank structure 2.

The heating of the cellulose blank structure 2 may take place before the pressing in the multi-cavity forming mould system S or at least partly before the pressing in the multi-cavity forming mould system S. As an alternative, the heating of the cellulose blank structure 2 may take place in the first mould part 3 and/or the second mould part 4 when being pressed, as schematically illustrated in FIGS. 1a-f and 2a-c. The heating of the cellulose blank structure 2 may for example be accomplished through heating the forming mould 5 with the heating unit 7 integrated in the first mould part 3 and/or the second mould part 4. The forming pressure P_{F} may also be applied before heating the cellulose blank structure 2, and for example, the heating of the cellulose blank structure 2 may take place in the multi-cavity forming mould system S during pressing.

During forming of the cellulose products 1 the first mould part 3 and/or the second mould part 4 may be heated by the heating unit 7 to a forming mould temperature in the range 100-500° C., or alternatively in the range 100-700° C., to establish the forming temperature T_{F} in the range of 100° C. to 300° C. that needs to be applied to the cellulose blank structure 2. The heating unit 7 may be integrated in the first mould part 3 and/or the second mould part 4, and suitable heating devices are e.g. an electrical heater or a fluid heater. Other suitable heat sources may also be used.

The heating unit 7 may have any suitable configuration. A suitable heating unit, such as a heated forming mould part or heated forming mould parts may be used for establishing the forming temperature T_{F}. In the different embodiments, the forming pressure P_{F} is in the range 1-100 MPa, preferably 4-20 MPa, and the forming temperature T_{F} is in the range 100-300° C. By using a deformation element 8, the forming pressure P_{F} may be an isostatic forming pressure, as will be further described below.

For all embodiments, the first mould part 3 and/or the second mould part 4 may comprise deformation elements 8 for each first forming element 3a and/or second forming element 4a. The deformation elements 8 are configured for exerting the forming pressure P_{F} on the cellulose blank structure 2 in the forming cavity 5 during forming of the cellulose products 1. The deformation elements 8 may be attached to the first mould part 3 and/or the second mould part 4 with suitable attachment means, such as for example glue or mechanical fastening members. In the embodiment schematically illustrated in FIGS. 2a-c, a deformation element 8 is attached to each of the first forming elements 3a.

During the forming of the cellulose products 1, the deformation elements 8 are deformed to exert the forming pressure P_{F} on the cellulose blank structure 2 in the forming cavities 5 and through deformation of the deformation elements 8, an even pressure distribution is achieved even if the cellulose products 1 are having complex three-dimensional shapes or if the cellulose blank structure 2 is having a varied thickness. In FIG. 2c, the deformation elements 8 are schematically shown in a deformed state corresponding to the shape of the cellulose products 1.

The deformation elements 8 are as described above being deformed during the forming process, and the deformation elements 8 are during forming of the cellulose products 1 arranged to exert the forming pressure P_{F} on the cellulose blank structure 2. To exert a required forming pressure P_{F} on the cellulose blank structure 2, the deformation elements 8 are made of a material that can be deformed when a force or pressure is applied, as schematically indicated in FIG. 2c for illustrative purposes, where the deformation elements 8 are deformed during the forming process. For example, the deformation elements 8 can be made of an elastic material capable of recovering size and shape after deformation. The deformation elements 8 may further be made of a material with suitable properties that is withstanding the high forming pressure P_{F} and forming temperature T_{F} levels used when forming the cellulose products 1.

During the forming process, the deformation elements 8 are deformed to exert the forming pressure P_{F} with the specific forming pressure level P_{FL} on the cellulose blank structure 2. Through the deformation, an even pressure distribution can be achieved, even if the cellulose products 1 are having complex three-dimensional shapes with cutouts, apertures and holes, or if the cellulose blank structure 2 used is having varying density, thickness, or grammage levels.

Certain elastic or deformable materials have fluid-like properties when being exposed to high pressure levels. If the deformation elements 8 are made of such a material, an even pressure distribution can be achieved in the forming process, where the pressure exerted on the cellulose blank structure 2 from the deformation elements 8 is equal or essentially equal in all directions between the mould parts. When the deformation elements 8 during pressure is in its fluid-like state, a uniform fluid-like pressure distribution is achieved. The forming pressure is with such a material thus applied to the cellulose blank structure 2 from all directions, and the deformation elements 8 are in this way during the forming of the cellulose products 1 exerting an isostatic forming pressure on the cellulose blank structure 2, as schematically indicated with arrows in FIG. 2c for illustrative purposes. The isostatic forming pressure from the deformation elements 8 is establishing a uniform pressure in all desired directions on the cellulose blank structure 2 in the forming cavities 5, such as perpendicular to the wall surface of the forming cavities 5. The isostatic forming pressure is providing an efficient forming process of the cellulose products 1, and the cellulose products 1 can be produced with high quality even if having complex shapes. According to the disclosure, when forming the cellulose products, the forming pressure level P_{FL} may for all embodiments be an isostatic forming pressure of at least 1 MPa, preferably 4-20 MPa.

The deformation elements 8 may be made of a suitable structure of elastomeric material, where the material has the ability to establish a uniform pressure on the cellulose blank structure 2 during the forming process. As an example, the deformation elements 8 may be made of a massive structure or an essentially massive structure of silicone rubber, polyurethane, polychloroprene, or rubber with a hardness in the range 20-90 Shore A. Other materials for the deformation elements 8 may for example be suitable gel materials, liquid crystal elastomers, and MR fluids.

In FIG. 3, an exemplified production unit layout of the multi-cavity forming mould system S is schematically shown, where the multi-cavity forming mould system S has the configuration shown in FIGS. 1a-f. A suitable cellulose pulp structure for forming the cellulose blank structure 2 is arranged on a roll 9, from which the pulp structure is fed to a mill unit 10. The mill unit 10 is arranged for separating fibers from the pulp structure and for distributing the separated fibers into a forming chamber 11. The mill unit 10 may be of any conventional type, such as for example a saw tooth mill, a hammer mill, or other type of pulp de-fiberizing machine, where the pulp structure is fed into the mill unit 10 through an inlet opening, and separated fibers are distributed to the forming chamber 11. A forming wire 12 is in this embodiment arranged in connection to the forming chamber 11, and the forming chamber 11 is forming an at least partly enclosed volume above the forming wire 12. The cellulose fibers in the pulp structure is separated in the mill unit 10 and arranged on the forming wire 12 for air-forming the cellulose blank structure 2. The separated fibers may instead in an alternative non-illustrated embodiment be fed directly from the mill unit 10 to the mould parts without a forming chamber.

The formed cellulose blank structure 2 may be forwarded intermittently to the multi-cavity forming mould system S for establishing a continuous production flow, as illustrated in FIG. 3. In the shown embodiment, the multi-cavity forming mould system S comprises a clamping unit 13 for locking the first mould part 3 in connection to the second mould part 4 during the forming of the cellulose products. In the shown embodiment, the clamping unit 13 comprises arms that are used for locking the first mould part 3 and the second mould part 4 in relation to each other in the position illustrated in FIG. 1d. The forming of the cellulose products 1 is achieved in the way described above in relation to FIGS. 1a-f. Residual cellulose blank structure 2a remaining after the forming of the cellulose products 1 is reused and fed again into the mill unit 10 together with pulp structure from the roll 9.

In FIG. 4, a similar alternative exemplified system layout of the multi-cavity forming mould system is schematically shown, where the pulp structure is arranged on rolls 9. The multi-cavity forming mould system S has the configuration shown in FIGS. 1a-f. The mill unit 10 is arranged for separating fibers from the pulp structure and for distributing the separated fibers into a forming chamber 11. The mill unit 10 may be of any conventional type, such as for example a saw tooth mill, a hammer mill, or other type of pulp de-fiberizing machine. A forming wire 12 is in this embodiment arranged in connection to the forming chamber 11. The cellulose fibers in the pulp structure is separated in the mill unit 10 and arranged on the forming wire 12 for air-forming the cellulose blank structure 2. In the embodiment shown in FIG. 4, the multi-cavity forming mould system S comprises a clamping unit 13 for locking the first mould part 3 in connection to the second mould part 4 during the forming of the cellulose products. The clamping unit 13 may be of toggle-type, comprising arms that are used for locking the first mould part 3 and the second mould part 4 in relation to each other in the position illustrated in FIG. 1d. The forming of the cellulose products 1 is achieved in the way described above in relation to FIGS. 1a-f. Residual cellulose blank structure 2a remaining after the forming of the cellulose products 1 is reused and fed again into the mill unit 10 together with pulp structure from the roll 9.

The multi-cavity forming mould system S may, as indicated above, further comprise a suitable control unit for controlling the forming of the cellulose products 1. The control unit may comprise, suitable software and hardware for controlling the multi-cavity forming mould system S, and the different process and method steps performed by the multi-cavity forming mould system S. The control unit may for example control the temperature, pressure, the forming time, and other process parameters. The control unit may further be connected to related process equipment, such as for example, pressing units, heating units, cellulose blank structure transportation units, and cellulose product transportation units.

The present disclosure has been presented above with reference to specific embodiments. However, other embodiments than the above described are possible and within the scope of the disclosure. Different method steps than those described above, performing the method by hardware or software, may be provided within the scope of the disclosure. Thus, according to an exemplary embodiment, there is provided a non-transitory computer-readable storage medium storing one or more programs configured to be executed by one or more processors of the multi-cavity forming mould system S, the one or more programs comprising instructions for performing the method according to any one of the above-discussed embodiments. Alternatively, according to another exemplary embodiment a cloud computing system can be configured to perform any of the method aspects presented herein. The cloud computing system may comprise distributed cloud computing resources that jointly perform the method aspects presented herein under control of one or more computer program products.

The processor or processors associated with the multi-cavity forming mould system S may be or include any number of hardware components for conducting data or signal processing or for executing computer code stored in memory. The system may have an associated memory, and the memory may be one or more devices for storing data and/or computer code for completing or facilitating the various methods described in the present description. The memory may include volatile memory or non-volatile memory. The memory may include database components, object code components, script components, or any other type of information structure for supporting the various activities of the present description. According to an exemplary embodiment, any distributed or local memory device may be utilized with the systems and methods of this description. According to an exemplary embodiment the memory is communicably connected to the processor (e.g., via a circuit or any other wired, wireless, or network connection) and includes computer code for executing one or more processes described herein.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims. Reference signs mentioned in the claims should not be seen as limiting the extent of the matter protected by the claims, and their sole function is to make claims easier to understand.

1. A multi-cavity forming mould system for forming a plurality of discrete three-dimensional cellulose products from an air-formed cellulose blank structure, the forming mould system (S) comprising:
a first mould part and a second mould part arranged for cooperating with each other during forming of the cellulose products,
wherein the first mould part comprises a plurality of first forming elements and the second mould part comprises a plurality of corresponding second forming elements, wherein the second forming elements are movably arranged in relation to a base structure of the second mould part,
wherein the forming mould system is configured for establishing a plurality of forming cavities for the cellulose blank structure between each first forming element and corresponding second forming element during forming of the cellulose products,
wherein each second forming element is arranged for interacting with a pressure member arranged in the base structure, wherein the pressure member is configured for establishing a forming pressure in each forming cavity onto the cellulose blank structure during forming of the cellulose products.

2. The multi-cavity forming mould system according to claim 1, wherein the first mould part and the second mould part are movably arranged in relation to each other.

3. The multi-cavity forming mould system according to claim 1, wherein the forming mould system is configured for establishing the forming pressure upon movement of each second forming element in relation to the base structure through interaction from the pressure member.

4. The multi-cavity forming mould system according to claim 1, wherein the forming mould system through interaction from the pressure member is configured for establishing a forming pressure level of at least 1 MPa in each forming cavity during forming of the cellulose products.

5. The multi-cavity forming mould system according to claim 1, wherein the pressure member comprises a plurality of spring units arranged between the base structure and each of the plurality of second forming elements.

6. The multi-cavity forming mould system according to claim 1, wherein the pressure member comprises a hydraulic pressure unit, wherein the hydraulic pressure unit comprises a plurality of pressure chambers arranged between the base structure and each of the plurality of second forming elements.

7. The multi-cavity forming mould system according to claim 1, wherein the forming mould system comprises a heating unit configured for heating the cellulose blank structure to a forming temperature in the range of 100° C. to 300° C. during forming of the cellulose products.

8. A method for forming a plurality of discrete three-dimensional cellulose products from an air-formed cellulose blank structure in a multi-cavity forming mould system, wherein the forming mould system comprises a first mould part and a second mould part arranged for cooperating with each other during forming of the cellulose products, wherein the first mould part comprises a plurality of first forming elements and the second mould part comprises a plurality of corresponding second forming elements, wherein the second forming elements are movably arranged in relation to a base structure of the second mould part, wherein each second forming element is arranged for interacting with a pressure member arranged in the base structure, wherein the method comprises the steps:
providing the air-formed cellulose blank structure, wherein the cellulose blank structure is air-formed from cellulose fibers, and arranging the cellulose blank structure between the first mould part and the second mould part;
establishing a plurality of forming cavities for the cellulose blank structure between each first forming element and corresponding second forming element; and
establishing a forming pressure in each forming cavity onto the cellulose blank structure with the pressure member during forming of the cellulose products.

9. The method according to claim 8, further comprising moving the first mould part and the second mould part in a direction towards each other after arranging the cellulose blank structure between the first mould part and the second mould part for establishing the plurality of forming cavities for the cellulose blank structure.

10. The method according to claim 8, further comprising establishing the forming pressure upon movement of each second forming element in relation to the base structure through interaction from the pressure member.

11. The method according to claim 8, further comprising establishing a forming pressure level of at least 1 MPa in each forming cavity through interaction from the pressure member.

12. The method according to claim 8, wherein the pressure member comprises a plurality of spring units arranged between the base structure and each of the plurality of second forming elements, wherein the spring units are establishing the forming pressure in each forming cavity onto the cellulose blank structure.

13. The method according to claim 8, wherein the pressure member comprises a hydraulic pressure unit, wherein the hydraulic pressure unit comprises a plurality of pressure chambers arranged between the base structure and each of the plurality of second forming elements, wherein the hydraulic pressure unit is establishing the forming pressure in each forming cavity onto the cellulose blank structure.

14. The method according to claim 8, wherein the forming mould system comprises a heating unit, wherein the method further comprises heating the cellulose blank structure to a forming temperature in the range of 100° C. to 300° C. during forming of the cellulose products.

15. The multi-cavity forming mould system according to claim 1, wherein the forming mould system through interaction from the pressure member is configured for establishing a forming pressure level in the range of 4-20 MPa in each forming cavity during forming of the cellulose products.

16. The method according to claim 8, further comprising establishing a forming pressure level in the range of 4-20 MPa in each forming cavity through interaction from the pressure member.
